(19) United States
(12) Patent Application Publication
(10) Pub. No.: US 2007/0299920 A1
(43) Pub. Date: Dec. 27, 2007

(54) Anonymous Email Address Management

(76) Inventors: Arturo E. Crespo, Sunnyvale, CA (US); Louis V. Perrochon, Mountain View, CA (US); Eric Mao, San Jose, CA (US); Benjamin Ling, San Francisco, CA (US)

Correspondence Address: GOOGLE / FENWICK, SILICON VALLEY CENTER, 801 CALIFORNIA ST., MOUNTAIN VIEW, CA, 94041, US

(21) Appl. No.: 11/426,824

(22) Filed: Jun. 27, 2006

(51) Int. Cl. G06F 15/16

(52) U.S. Cl. 709/206

(57) ABSTRACT

A system, method, and a computer program product generates an anonymous email address corresponding to a pair of customer and merchant. Based on the received customer identifier and merchant identifier, an anonymous email key and address are generated. The anonymous email address is then used in communications between the customer and merchant.

### BACKGROUND

This invention pertains in general to electronic commerce, and in particular to a system generating anonymous email addresses for transactions between customers and Internet-based merchants.

Electronic commerce on the Internet has become commonplace. There are many merchants offering goods and services via websites on the Internet, and there are an even greater number of customers who purchase the goods and services. In many cases, the electronic commerce transactions involve physical goods. For example, many customers purchase items such as books, compact disks (CDs) and DVDs via the Internet. Customers can also purchase electronic content such as downloadable text and/or music and access to websites that provide news or entertainment stories.

Most electronic commerce sites on the Internet require customers to disclose a personal email address to the merchant from whom they make a purchase. Unless the merchant agrees not to use the customer's personal e-mail address for other purposes, the merchant is free to perform data mining on the customer's e-mail address, send unsolicited e-mail (spam) to the customer or sell the customer's e-mail address to others. Even if the online merchant agrees not to use the customer's e-mail address, nothing prevents the merchant from later breaking this promise. Also, many merchants do not make any agreements regarding use of the customer's e-mail. Therefore, many customers ultimately receive considerable amounts of spam because of their online transactions.

### SUMMARY

A method, system, and a computer program product for generating and managing customers' anonymous email addresses that are used in communications between the customers and a merchant.

A customer visits the merchant's web site and selects one or more items to purchase. A “customer,” as used herein, refers to a user transacting business with a merchant, or, a user who has not conducted business with a merchant, but who desires to communicate with a merchant anonymously. The merchant places the items in a virtual shopping cart, and offers the customer the option to checkout using a broker. If the customer selects this option, he or she is directed by the merchant to a broker website. The broker authenticates the customer. In one embodiment, the authentication triggers the broker to display to the customer email address options.

The broker examines transaction identification information received through the authentication and determines whether an anonymous email address exists for the received customer ID and merchant ID. If no anonymous email address corresponding to the specified customer ID and merchant ID exists, the broker uses the transaction identification information to generate a new anonymous email key and an anonymous email address and stores the received information and new anonymous email key and address.

If the customer chooses not to generate a new anonymous email address, the transaction with the merchant continues using the customer's real email address according to one embodiment. In another embodiment, the merchant has the option of opting out of use of anonymous emails, requiring the customer to enter a real email address. For example, if a customer attempts to use an anonymous email address, a prompt may display.

The features and advantages described in this summary are not all inclusive and, in particular, many additional features and advantages will be apparent to one of ordinary skill in the art in view of the drawings, specification, and claims.

### BRIEF DESCRIPTION OF THE DRAWINGS

FIG. 1 is a high-level block diagram of a computing environment according to one embodiment of the present invention.

FIG. 2 is a high-level block diagram illustrating a functional view of a typical computer system for use as one of the entities illustrated in the environment of FIG. 1 according to an embodiment of the present invention.

FIG. 3 is a high-level block diagram illustrating modules within a customer according to one embodiment.

FIG. 4 is a high-level block diagram illustrating modules within a merchant according to one embodiment.

FIG. 5 is a high-level block diagram illustrating modules within the broker according to one embodiment.

FIG. 6 is a flow chart illustrating the operation of the broker according to one embodiment.

FIG. 7 is a flow chart illustrating the generation of an anonymous email address according to one embodiment.

FIG. 8 is a flow chart illustrating the use of an anonymous email by a merchant to communicate with a customer according to one embodiment.

FIG. 9 is an illustration of an anonymous email account management user interface according to one embodiment.

FIGS. 10A and 10B are illustrations of a checkout confirmation page from a merchant website according to one embodiment.

FIG. 11 is an illustration of a customer receipt page according to one embodiment.

FIG. 12 is an illustration of an email order confirmation email according to one embodiment.

FIG. 13A is an illustration of an anonymous email interface according to one embodiment.

FIG. 13B is an illustration of a blank anonymous email according to one embodiment.

FIG. 13C is an illustration of an anonymous email pre-populated with transaction details according to one embodiment.

The figures depict an embodiment of the present invention for purposes of illustration only. One skilled in the art will readily recognize from the following description that alternative embodiments of the structures and methods illustrated herein may be employed without departing from the principles of the invention described herein.

### DETAILED DESCRIPTION OF THE PREFERRED EMBODIMENTS

### I. OVERVIEW

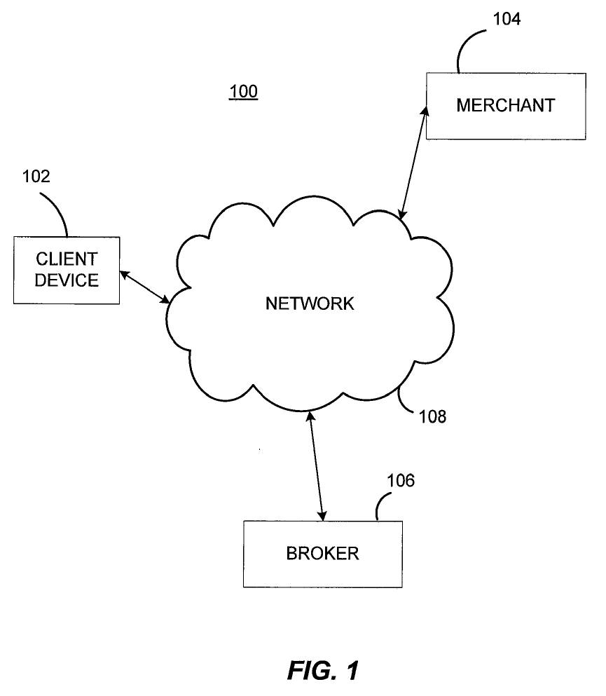

FIG. 1 is a high-level block diagram of a computing environment 100 according to one embodiment of the present invention. FIG. 1 illustrates a client device 102, a merchant 104, and a broker 106 connected by a network 108.

The client device 102 in this embodiment represents an entity that obtains items via the network 108 through purchases or other types of transactions. The client device 102 is sometimes referred to as the “customer” and is understood to represent the person who is the conducting the transaction with a merchant. The transaction is sometimes referred to as a “sale” or “purchase.” As used herein, these terms also refer to other types of transactions, regardless of whether the customer is technically a “customer” or the transaction is technically a “sale.”

In one embodiment, the client device 102 includes a computer system that is utilized by an end-user to communicate with other computers on the network 108 in order to effect a purchase. The computer system, for example, can be a personal computer executing a web browser such as MICROSOFT INTERNET EXPLORER that allows the end-user to retrieve and display content from web servers and other computer systems on the network 108. In other embodiments, the client device 102 includes a network-capable device other than a computer system, such as a personal digital assistant (PDA), a cellular telephone, a pager, a television “set-top box” etc. Although FIG. 1 illustrates only a single client device 102, embodiments of the present invention can have thousands or millions of customers participating in the electronic commerce system described herein. The single client device 102 is illustrated in order to simplify and clarify the present description. As used herein, the reference number 102 refers to both a single customer and/or a set of customers, depending upon the context.

Similarly, the merchant 104 represents an entity that sells items on the network 108 or makes items available through types of transactions. The merchant 104 offering the item to the customer is sometimes referred to as the “seller” and the transaction is sometimes referred to as a “sale” or “purchase.” As used herein, these terms also refer to other types of transactions, regardless of whether the merchant is technically a “seller” or the transaction is technically a “sale.”

In one embodiment, the merchant 104 includes a computer system acting as a web server that is utilized to offer the items to potential customers 102. The items offered by the merchant 104 can include tangible items such as books, CDs, DVDs, digital cameras and other types of electronic goods, etc. The items offered by the merchant 104 can also include intangible items such as services and electronic content such as web pages, downloadable files, streaming media, etc. Although FIG. 1 illustrates only a single merchant 104, embodiments of the present invention can have many merchants participating in the electronic commerce system. The single merchant 104 is illustrated in order to simplify and clarify the present description. As used herein, the reference number 104 refers to both a single merchant and/or a set of merchants, depending upon the context.

The broker 106 represents an entity that serves as an intermediary for the transaction between the client device 102 and the merchant 104. In one embodiment, the broker 106 operates a system that functions as a centralized place that the customers 102 can use to pay for items offered by the merchants. Thus, the customers 102 can patronize multiple merchants 104 while providing their payment information to only the broker 106. In another embodiment, the broker 106 operates a system that enables customers 102 and merchants 104 to communicate anonymously. Thus, the customers 102 can patronize merchants 104 without using the customers' personal email addresses. Although FIG. 1 illustrates only a single broker 106, embodiments of the present invention can have multiple brokers participating in the electronic commerce system. In one embodiment, the broker 106 is said to be “remote” from the client device 102 and/or merchant 104. “Remote” in this context means that the broker is logically separate from the customer and/or merchant, and does not necessarily refer to a physical distance between the entities.

The network 108 represents the communication pathways between the client device 102, merchant 104, and broker 106. In one embodiment, the network 108 is the Internet. The network 108 can also utilize dedicated or private communications links that are not necessarily part of the Internet. In one embodiment, the network 108 uses standard communications technologies and/or protocols. Thus, the network 108 can include links using technologies such as 802.11, integrated services digital network (ISDN), digital subscriber line (DSL), asynchronous transfer mode (ATM), etc. Similarly, the networking protocols used on the network 108 can include multiprotocol label switching (MPLS), the transmission control protocol/Internet protocol (TCP/IP), the hypertext transport protocol (HTTP), the simple mail transfer protocol (SMTP), the file transfer protocol (FTP), etc. The data exchanged over the network 108 can be represented using technologies and/or formats including the hypertext markup language (HTML), the extensible markup language (XML), etc. In addition, all or some of links can be encrypted using conventional encryption technologies such as the secure sockets layer (SSL), Secure HTTP and/or virtual private networks (VPNs). In another embodiment, the entities can use custom and/or dedicated data communications technologies instead of, or in addition to, the ones described above.

### II. SYSTEM ARCHITECTURE

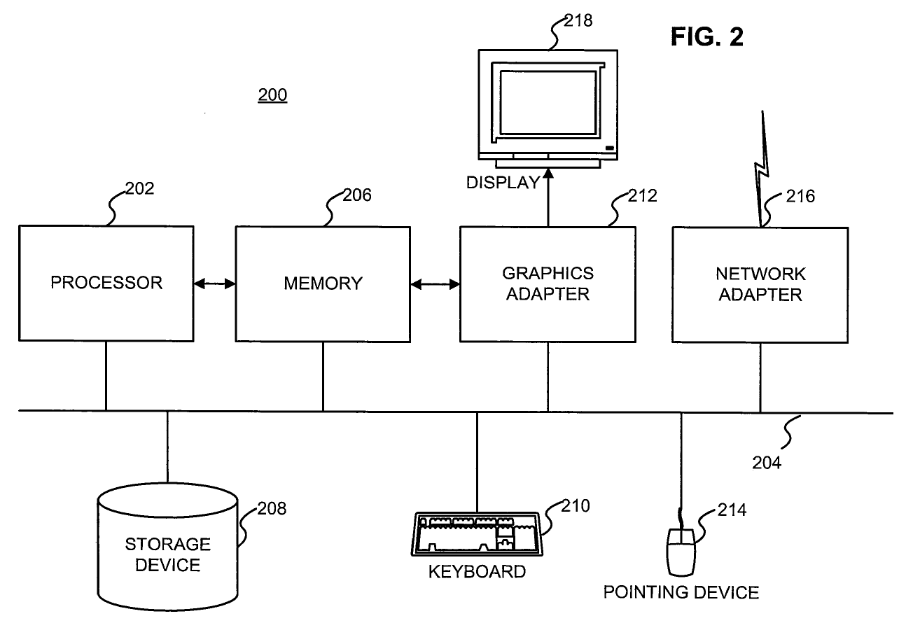

FIG. 2 is a high-level block diagram illustrating a functional view of a typical computer system 200 for use as one of the entities illustrated in the environment 100 of FIG. 1 according to an embodiment of the present invention. Illustrated are at least one processor 202 coupled to a bus 204. Also coupled to the bus 204 are a memory 206, a storage device 208, a keyboard 210, a graphics adapter 212, a pointing device 214, and a network adapter 216. A display 218 is coupled to the graphics adapter 212.

The processor 202 may be any general-purpose processor such as an INTEL x86, SUN MICROSYSTEMS SPARC, or POWERPC compatible-CPU. The storage device 208 is, in one embodiment, a hard disk drive but can also be any other device capable of storing data, such as a writeable compact disk (CD) or DVD, or a solid-state memory device. The memory 206 may be, for example, firmware, read-only memory (ROM), non-volatile random access memory (NVRAM), and/or RAM, and holds instructions and data used by the processor 202. The pointing device 214 may be a mouse, track ball, or other type of pointing device, and is used in combination with the keyboard 210 to input data into the computer system 200. The graphics adapter 212 displays images and other information on the display 218. The network adapter 216 couples the computer system 200 to the network 108.

As is known in the art, the computer system 200 is adapted to execute computer program modules. As used herein, the term “module” refers to computer program logic and/or data for providing the specified functionality. A module can be implemented in hardware, firmware, and/or software. In one embodiment, the modules are stored on the storage device 208, loaded into the memory 206, and executed by the processor 202.

The types of computer systems 200 utilized by the entities of FIG. 1 can vary depending upon the embodiment and the processing power utilized by the entity. For example, the client device 102 typically requires less processing power than the merchant 104 and broker 106. Thus, the customer computer system can be a standard personal computer system. The merchant and broker computer systems, in contrast, may comprise more powerful computers and/or multiple computers working together to provide the functionality described herein.

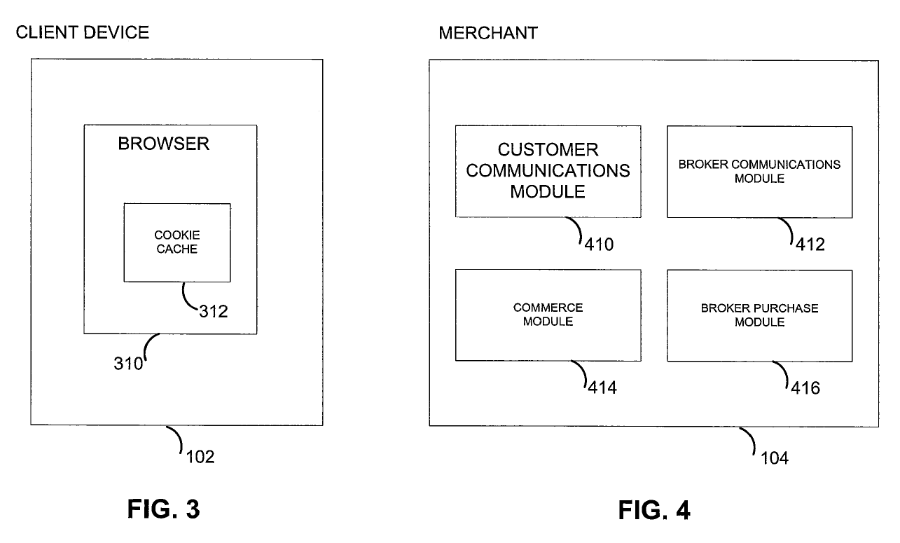

FIG. 3 is a high-level block diagram illustrating modules within a client device 102 according to one embodiment. Those of skill in the art will recognize that other embodiments can have different and/or other modules than the ones described here, and that the functionalities can be distributed among the modules in a different manner.

As shown in FIG. 3, the client device 102 includes a browser module 310 that allows the customer to view web pages provided by the merchant 104, broker 106, and/or other entities on the network 108. In one embodiment, the browser module 310 is a conventional web browser, such as MICROSOFT INTERNET EXPLORER or MOZILLA FIREFOX. In one embodiment, the browser module 310 maintains a cookie cache 312 that stores cookies associated with websites on the network 108. The merchant 104 and broker 106 can communicate with the browser module 310 and instruct it to create a cookie in the cookie cache 312 holding certain information. The browser module 310 provides the cookie to the merchant 104 and/or broker 106 when the browser connects to the site that created it.

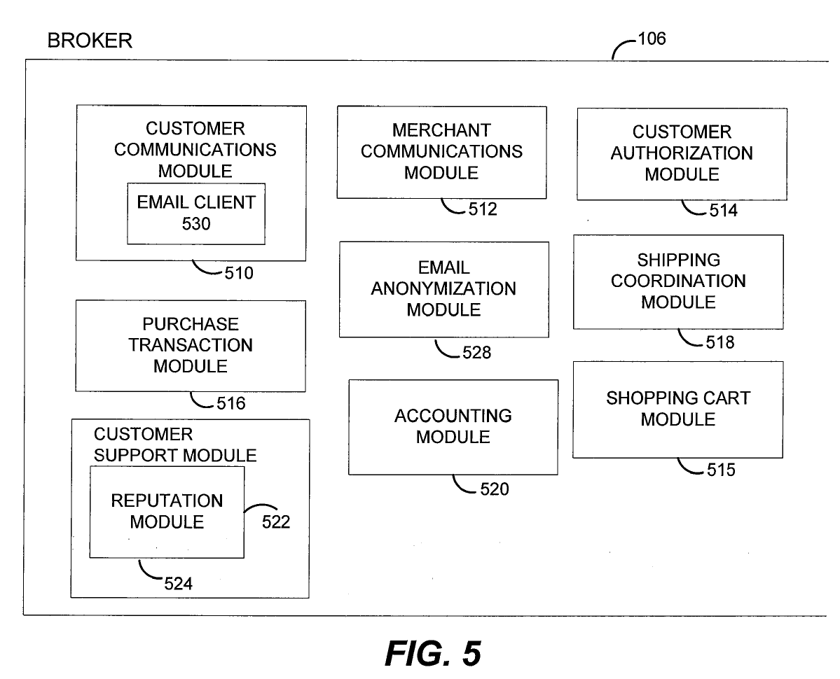

FIG. 4 is a high-level block diagram illustrating modules within a merchant 104 according to one embodiment. Those of skill in the art will recognize that other embodiments can have different and/or other modules than the ones described here, and that the functionalities can be distributed among the modules in a different manner.

A customer communications module 410 communicates with the client device 102 via the network 108 (as shown in FIG. 1). In one embodiment, the customer communications module 410 includes a web server (not shown in FIG. 4) that provides web pages to the client device 102 and receives end-user input sent over the network 108 by the customer's browser module 310. The customer communications module 410 thus allows a customer to navigate the merchant's website.

In one embodiment, a broker communications module 412 communicates with the broker 106 via the network 108 (as shown in FIG. 1). Merchant-broker communications may be conducted using the web services description language (WSDL). In one embodiment, the broker communications module 412 uses WSDL to describe the services it provides and ascertain the services provided by the broker 106. The broker communications module 412 uses XML-based remote procedure calls (RPCs) to provide information to the broker 106 and receive information in return. In other embodiments, the broker communications module 412 communicates with the broker 106 using other techniques and/or protocols, such as via email messages, HTML web pages intended for review by human users, proprietary communications protocols, etc.

A commerce module 414 operates in tandem with the customer communications module 410 and allows the client device 102 to engage in electronic commerce transactions with the merchant 104. In general, the commerce module 414 allows the merchant 104 to create and manage a catalog of items available for sale. The client device 102 can browse the catalog and indicate items that the client device 102 desires to purchase. In one embodiment, the commerce module 414 utilizes a shopping cart metaphor where items selected by the client device 102 are placed in a virtual shopping cart. The customer can “checkout” and purchase the items in the shopping cart. In one embodiment, the commerce module 414 includes functionality from the open source osCommerce package.

The commerce module 414 provides the client device 102 with one or more payment options at the time of checkout. For example, one payment option can allow the client device 102 to provide payment information directly to the merchant 104. Another payment option can reference an alternative payment system, such as the payment system provided by the broker 106. This latter option may be more desirable to the client device 102 when, for example, the merchant 104 is not well known and the customer is reluctant to provide the payment information to the merchant. The broker 106, on the other hand, may be well known to the client device 102 and an entity to which the client device 102 is comfortable providing payment information. In one embodiment, the commerce module 414 provides a graphic, slogan, and/or other indicia that represents the broker 106 and is designed to convey a sense of trustworthiness to the client device 102.

A broker purchase module 416 interacts with the broker communications module 412 to process a customer purchase. The broker purchase module 416 is activated if a client device 102 selects the broker payment system for a purchase. In one embodiment, the broker purchase module 416 generates a description of the customer's shopping cart, and presents the customer with an option to request for the broker to generate an anonymous email for this transaction. In one embodiment, the description is encoded in XML, although other techniques can also be used. The description describes the items in the cart, including the type and number of items purchased, and the prices of the items. In one embodiment, the shopping cart description also includes shipping rules describing shipping options and/or rates for the items in the cart, taxation rules applicable to the items, a merchant ID that uniquely identifies the merchant 104, and/or a transaction ID that uniquely identifies the specific purchase transaction. The shopping cart description can also include anticipated shipping dates and/or order processing times. In another embodiment, the shopping cart description also includes an option allowing the customer to generate an email address to use for communicating with the merchant 104. The broker purchase module 416 digitally signs the shopping cart description to prevent third parties from making modifications to it.

In one embodiment, the broker purchase module 416 utilizes the broker communications module 412 to send the shopping cart description to the broker 106. In another embodiment, the broker purchase module 416 uses the customer communications module 410 to provide the shopping cart description to the client device 102 and direct the customer's browser module 310 to send it to the broker 106. The broker purchase module 416 can perform this latter task by, for example, by using a HTTP GET method that codes the shopping cart description into a uniform resource locator (URL) that references the broker 106, and redirecting the customer's browser 310 to the coded URL. In another example, the broker purchase module 416 can use a HTTP POST method that codes the shopping cart description into the body of a request made from the customer's browser 110 to the broker 106.

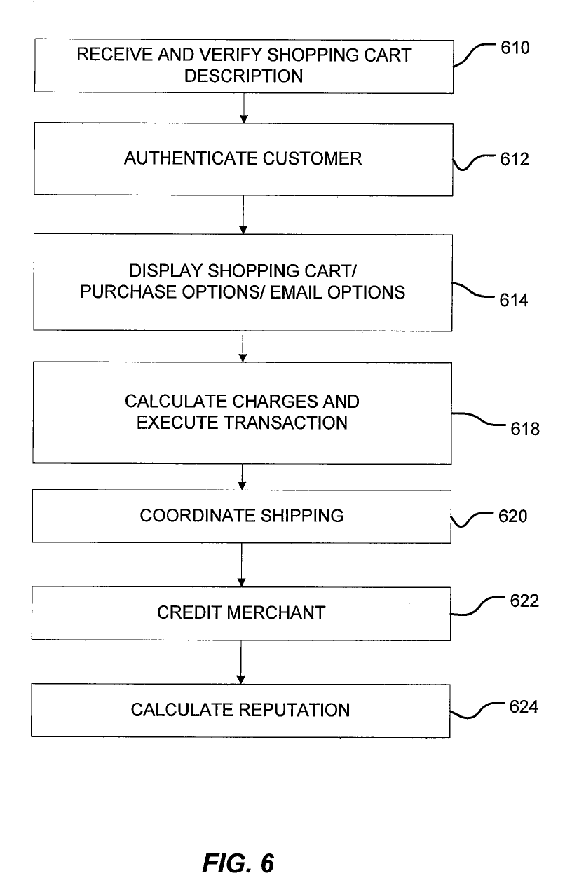

FIG. 5 is a high-level block diagram illustrating modules within the broker 106 according to one embodiment. Those of skill in the art will recognize that other embodiments can have different and/or other modules than the ones described here, and that the functionalities can be distributed among the modules in a different manner.

A customer authorization module 514 authenticates and authorizes customers 102 seeking to use the broker 106 for purchases. In one embodiment, the customer authorization module 514 maintains a customer ID, password, email address, and/or other information, such as shipping address, payment information for each customer, as well as information identifying the customer's client device 102 (e.g., an IP address, cookie or the like). The authorization module 514 stores this information in a customer table in a database. The client device 102 supplies the correct information in order to identify and authenticate the customer and itself. In general, when a client device 102 contacts the broker 106 to make a purchase, the customer's relationship with the broker 106 fits into one of three categories: a new customer, existing customer that has not been active recently, or existing active customer. In one embodiment, the customer authorization module 514 determines the category of the customer and responds accordingly. In one embodiment, customer authorization module 514 causes an email anonymization module 528 to examine the information stored in the customer table and determine whether an anonymous email address exists corresponding to the stored information.

If the customer is new, an embodiment of the customer authorization module 514 presents the customer with one or more web pages that allow the customer to create an account and select a customer ID, password and/or other identifing information. In one embodiment, the customer also supplies payment information specifying a charge account and/or creating a stored value. The payment information can include, for example, a credit card number or a gift certificate identifier. The customer can also supply information including mailing/shipping addresses and settings for miscellaneous preferences.

If the customer already has an account but has not been active recently (e.g., within the previous 10 minutes), in one embodiment the customer authorization module 514 provides the customer with the standard login prompt and thereby allows the customer to log into the broker 106. If the client device 102 has been active recently, one embodiment of the customer authorization module 514 allows the customer to directly access the broker 106 without additional authentication procedures. After each successful login, one embodiment of the customer authorization module 514 places a cookie in the customer's browser module 310 that identifies the customer and indicates the time of the customer's last login. In another embodiment, the cookie identifies the expiration date/time after which the customer's activity is no longer considered “recent.” The cookie thus allows the customer authorization module 514 to determine the customer's status with respect to the broker 106 and respond appropriately. In another embodiment, the customer authorization module 514 displays on the client device 102 a prompt for the customer to generate a new anonymous email address.

A purchase transaction module 516 receives the shopping cart description and allows the client device 102 to complete the purchase transaction for the items in the cart. In one embodiment, the purchase transaction module 516 presents the client device 102 with web pages that describe the items in the cart and allow the customer to specify the methods of payment and shipping, along with any other details that are necessary and/or desired for the transaction. The purchase transaction module 516 uses the shipping address specified by the client device 102 and the shipping rules received from the merchant to calculate the rates for the shipping options. Similarly, the purchase transaction module 516 uses the shipping address and taxation rules from the merchant 104 to calculate any taxes on the purchase. The purchase transaction module 516 determines the total cost of the purchase, charges the client device 102, and provides the customer with a receipt.

A shipping coordination module 518 interacts with the merchant 104 to inform the merchant of the purchase and coordinate shipping of the purchased items to the client device 102. In one embodiment, the shipping coordination module 518 provides the customer-indicated shipping address and shipping options to the merchant 102. In another embodiment, the shipping coordination module 518 instructs the merchant to ship the items to a placeholder or third-party address. In this latter embodiment, the broker 106 electronically notifies the carrier (e.g., Federal Express or United Parcel Service) to redirect the package to the customer's true shipping address. This embodiment thus keeps the client device 102 completely anonymous to the merchant 104. In yet another embodiment, use of an anonymous email address allows the customer to interact with a merchant 104 without providing the merchant 104 with the customer's personal information.

An accounting module 520 monitors the transactions that occur using the broker 106, invoices the customers 102, and credits the merchants 104. In a typical case, the accounting module 520 charges the customer's credit card or other method of payment and credits the merchant's account for the amount of the purchase. In another embodiment, the accounting module 520 aggregates purchases made by the customers and then periodically credits each merchant for the value of the purchases made within the time period. In yet another embodiment, the accounting module 520 aggregates a customer's purchases within a given time period and then charges the customer's account once for aggregate total of the purchases. This latter embodiment might be desirable where, for example, the client device 102 makes many small purchases.

A customer support module 522 allows customers 102 to request refunds and/or perform other customer-support related tasks. In one embodiment, the broker 106 provides a satisfaction guarantee and allows customers to obtain refinds on purchases with relative ease. This refund policy provides the customers 102 with added security and may make the customers more willing to purchase items from relatively unknown and/or untrustworthy merchants 104.

In one embodiment, the customer support module 522 includes a reputation module 524 that monitors transactions performed by the broker 106 and calculates reputation scores for the customers 102 and/or merchants 104. In one embodiment, the reputation module 524 calculates a volume rating that indicates the percentage of transactions for which a customer has requested a refind or otherwise disputed. Similarly, in one embodiment the reputation module 524 calculates an amount rating that indicates the cash value of a customer's disputed transactions as a percentage of the customer's total transactions. In another embodiment, the reputation module 524 calculates the percentages of merchants' sales that are disputed by the customers 102. In one embodiment the reputation scores are used to detect potential fraud.

The broker 106 also includes an email anonymization module 528 that communicates with the client device 102 and the merchant device 104 via the network 108 according to one embodiment. In one embodiment, the email anonymization module 528 includes an anonymous email server that transmits email messages to the client device 102 after receiving the email messages from the merchant device 104. Also, the email anonymization module 528 may transmit email messages to the merchant device 104 after receiving the email messages from the client device 102.

An email anonymization module 528 maintains transaction identification information in a customer table in a database. In one embodiment, the email anonymization module 528 maintains a separate email anonymization customer table for the transaction identification information. In another embodiment, it accesses some or all of the information from the customer table associated with the customer authorization module 514. In one embodiment, the email anonymization module 528 maintains in the customer table a customer ID, a merchant ID, a customer email address, a merchant email address, an anonymous email key, one or more anonymous email addresses, as well as one or more blocked/non-blocked flags and active/non-active status flags associated with the anonymous email addresses. The customer ID is an identifier, such as a user name, provided by the customer. The merchant ID is an identifier provided by the merchant. The customer email address is the real email address of the user and the merchant email address is the real email address of the merchant. The anonymous email key identifies the pair of customer and merchant email addresses, preserving privacy by avoiding merchant access to the real customer email address.

The anonymous email key is a generated ID that uniquely identifies the pair of customer and merchant email addresses. In some embodiments the anonymous email key is a character string of a specified length. In addition, the anonymous email key is checked for uniqueness.

The anonymous email key can be generated in any number of different ways; the minimal requirement is that it can be uniquely associated with at least a pair of customer and merchant email addresses. In other embodiments, the anonymous email key can be generated using a pseudo-random number generator. Yet another way of generating the anonymous email key is to concatenate randomly selected words and number sequences, such as “TurkeyHap281”.

In some embodiments, the anonymous email key can be a hash of stored values, such as the customer ID and merchant ID. The hash function is preferably a strong one-way hash such as MD5, RC4, HMAC, SHA or the like. In embodiments in which customers use multiple anonymous emails for a specific merchant, values other than the merchant ID and customer ID, e.g., a timestamp, random number, or other value, can be into the hash function to ensure the anonymous email key is unique. Those of skill in the art can readily device many different ways of generating anonymous email keys.

Using customer and merchant specific information (other than the merchant ID and customer ID) provides each entry with a unique piece of information that can be used to generate a new anonymous email key for each transaction. For example, if a customer makes repeated purchases from a merchant A, using only the customer ID and merchant ID would result in creation of the same anonymous email key for each transaction (assuming the same hash function is used each time). If other transaction specific information, such as a transaction timestamp, transaction ID, transaction amount or the like, is used along with the customer ID and merchant A's merchant ID to generate the anonymous email key, each transaction will have a different anonymous email key.

The email anonymization module 528 uses the anonymous email key to construct the anonymous email address, which in one embodiment is of the form “anonkey@server.com.” In this format, “anonkey” indicates that anonymous email key, and “server” is the domain of the anonymous email server. Of course, other forms of anonymous email addresses can be used as well, consistent with the teaching of the present invention.

The blocked/non-blocked flag indicates whether the customer permits the merchant, or third parties, to forward email to the customer's real email address from the anonymous email address. If the blocked/non-blocked flag indicates that the customer's email address is blocked, when the email anonymization module 528 receives an email message from the merchant 104 to the anonymous email address, the email anonymization module 528 does not forward the email message from the merchant 104 to the customer's real email address. If the blocked/non-blocked flag indicates that the customer's email address is not blocked, when the email anonymization module 528 receives an email message from the merchant 104 to the anonymous email address, the email anonymization module 528 forwards the email message from the merchant 104 to the customer's real email address. In embodiments in which customers may use multiple anonymous emails to communicate with a merchant 104, active/non-active status flags indicate which anonymous email address is being used for customer-merchant communications (i.e. which address is “active”) at a given time. Only one anonymous email address can be used for communication at a given time according to one embodiment; the active/non-active flags determine which anonymous email address to use for communications. As one anonymous email address should be active at a time, if there is only one anonymous email address, by default it is flagged as active. When there are multiple anonymous email addresses, only the one flagged as active is used for communication between customer and merchant; the inactive anonymous email addresses are stored, but unused until the flagged as active by the customer.

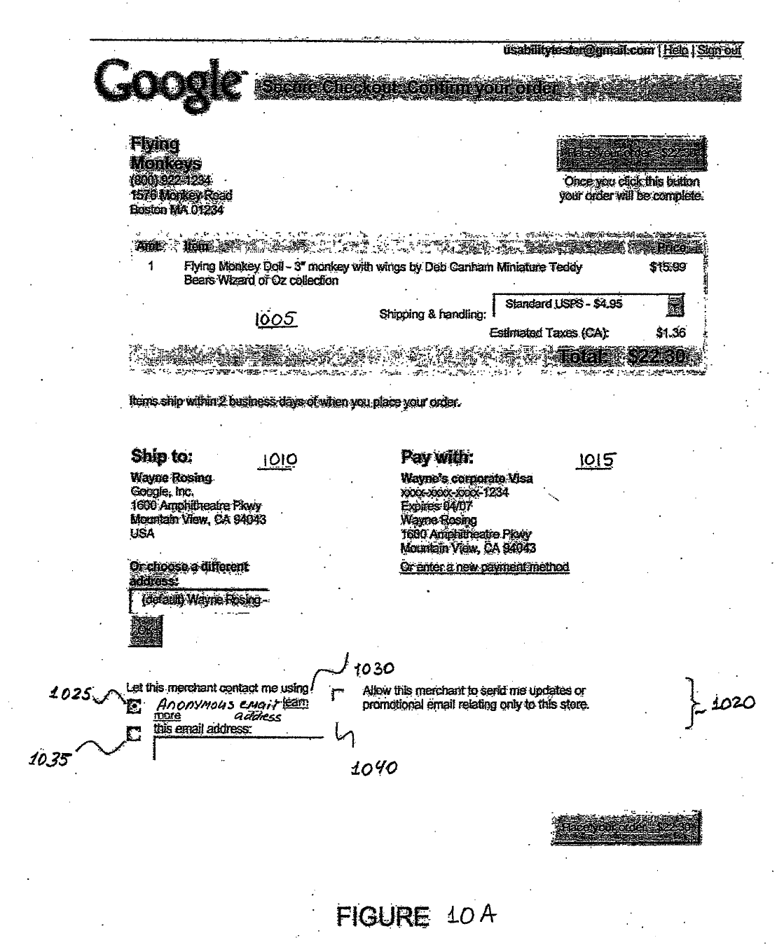

The email anonymization module 528 also provides an account management user interface allowing the customer to access and modify all of their anonymous email addresses, as well as perform other tasks. The account management user interface is described in greater detail in conjunction with FIG. 9.

The broker 106 also includes a customer communications module 510 and a merchant communications module 512 for respectively communicating with the client device 102 and the merchant 104. In one embodiment, these modules are functionally equivalent to the customer and broker communications modules in the merchant 104. In one embodiment, the account management user interface of the email anonymization module 528 uses the customer communications module 510 to provide customers with an email client to send emails using the generated anonymous email addresses. In another embodiment, the email anonymization module 528 uses the customer communications module 510 and the merchant communications module 512 to send messages from the merchant 104 addressed to the customer's anonymous email address on to the customer's real email address. In yet another embodiment, the email anonymization module 528 uses the customer communications module 510 to provide customers with an account management user interface to access or modify existing anonymous email addresses.

In various other embodiments, the broker 160 includes different components, such as an email address generator, message router, or other components providing the functionality described herein.

### III. METHODS OF OPERATION

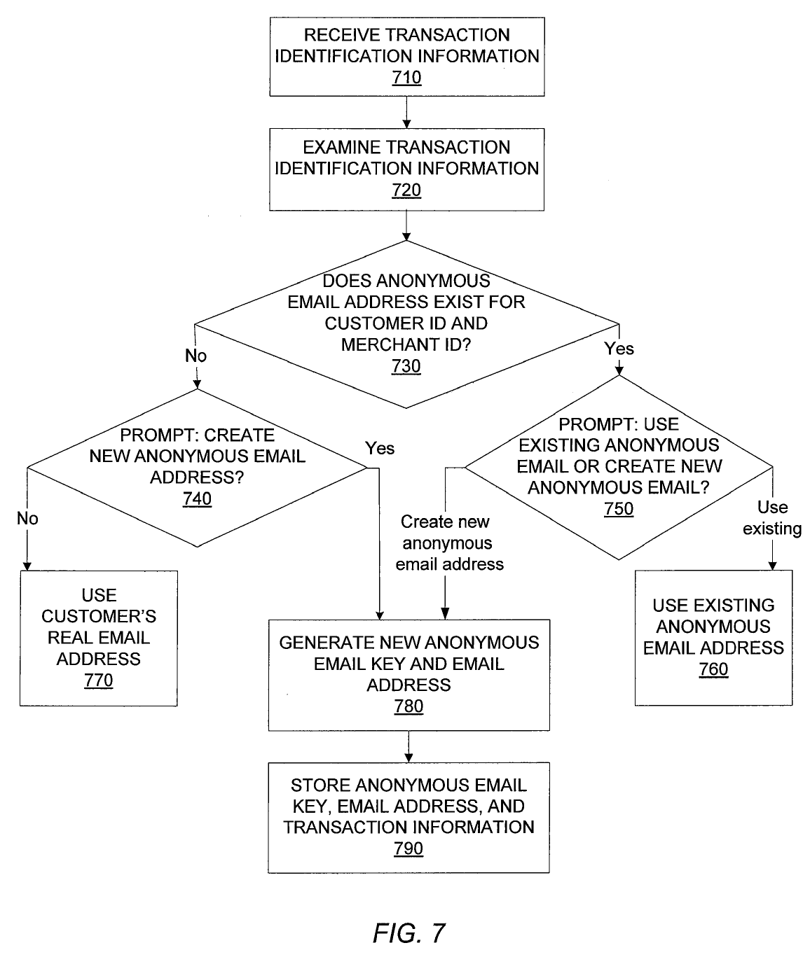

FIG. 6 is a flow chart illustrating the operation of the broker 106 according to one embodiment where a client device 102 is purchasing an item from a merchant 104. Those of skill in the art will recognize that other embodiments can perform the steps of FIG. 6 in different orders. Moreover, other embodiments can include different and/or additional steps than the ones described here.

Assume for purposes of this example that the client device 102 uses a web browser to browse the merchant's website and selects one or more items to purchase. The merchant 104 places the items in a virtual shopping cart and offers the client device 102 the option to checkout using the broker 106. The client device 102 selects this option and is directed by the merchant 104 to a broker website.

The broker 106 receives and verifies 610 the shopping cart description. In one embodiment the broker 106 receives the shopping cart description from the client device 102 as part of a URL or request. In another embodiment, the broker 106 receives the shopping cart description directly from the merchant 104. The broker 106 verifies the shopping cart description by, for example, verifing a digital signature of the merchant 104.

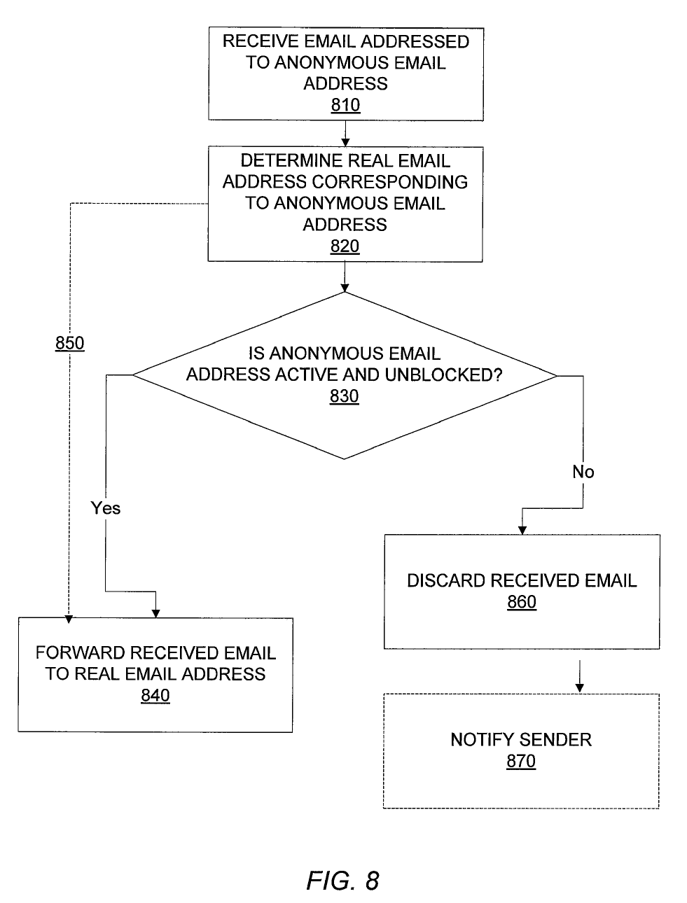

The broker 106 authenticates 612 the client device 102. This step can occur, for example, by asking the customer for an ID, password and/or other identifying information, reading a cookie provided by the customer's browser 310, and/or through another technique. The broker 106 displays 614 a representation of the shopping cart to the client device 102. The broker 106 also displays 614 web page buttons or another interface that the client device 102 uses to select purchase options, such as a shipping method and address. These purchase options are derived in part from data included in the shopping cart description. In one embodiment, authentication 612 triggers the broker 106 to display 614 to the customer an option to generate an anonymous email address on the client device 102 as described further in conjunction with FIG. 7. The client device 102 selects the desired options, and the broker 106 receives 616 the selections from the customer's browser 310.

The broker 106 uses the purchase options selected by the client device 102 to calculate 618 the total charge for the transaction. These calculations typically take into account the cost of the items in the cart, shipping method selected by the client device 102, applicable taxes, and/or any other charges described by the merchant 104 in the shopping cart description. The broker 106 executes 618 the transaction by charging the customer's credit card, subtracting a value from a stored value account, and/or performing an equivalent action.

The broker 106 coordinates 620 shipping with the merchant 104. In one embodiment, the broker 106 supplies the customer-indicated shipping address and method to the merchant 104 and instructs the merchant to ship the purchased items directly to the client device 102. In another embodiment, the broker 106 instructs the merchant to ship the items to a placeholder address. The broker 106 then communicates with the shipper to direct the package containing the items to the customer's shipping address.

The broker 106 credits 622 the merchant 104 for the transaction. In one embodiment, the broker 106 keeps percentage of the transaction and/or charges the merchant 104 a fee for conducting the transaction. In addition, the broker 106 calculates 624 the reputation of the client device 102 and/or merchant 104 in response to the transaction. The reputation may change based on subsequent events, such as the client device 102 requesting a refimd for the transaction.

The broker 106 thus serves as a centralized information store for the customers' data. This centralized store provides better security because it allows customers 102 to make purchases from multiple merchants 104 without providing the customers' personal data to each merchant. In fact, in one embodiment the customers 104 remain completely anonymous to the merchants 104. In addition, using the broker 106 is beneficial to merchants because it allows them to increase their sales by lowering their barriers to purchase and leveraging off the reputation and trustworthiness of the broker 106.

FIG. 7 is a flow chart illustrating the generation of the anonymous email address in one embodiment. Those of skill in the art will recognize that other embodiments can perform the steps of FIG. 7 in different orders. Moreover, other embodiments can include different and/or additional steps than the ones described here. Assume for purposes of this example that the client device 102 uses a web browser to browse the merchant's website, and selects one or more items to purchase. The merchant 104 places the items in a virtual shopping cart, and offers the client device 102 the option to checkout using the broker 106. The client device 102 selects this option and is directed by the merchant 104 to a broker website. In one embodiment, the broker 106 authenticates the client device 102. This step can occur, for example, by asking the customer for an ID, password, and/or other identifying information, reading a cookie provided by the customer's browser 310, and/or through another technique. As a result, the broker 106 receives 710 transaction identification information according to one embodiment. In one embodiment, the authentication triggers the broker 106 to display to the customer, on the client device 102, email address options.

The broker 106 examines 720 transaction identification information. In one implementation, to this end, the broker 106 examines the customer table and determines 730 whether an anonymous email address exists for the received customer ID and merchant ID. If no anonymous email address corresponding to the specified customer ID and merchant ID exists, the broker 106 adds an option to the representation of the shopping cart displayed on the client device 102 to prompt 740 the customer to generate a new anonymous email address.

If the customer chooses not to generate a new anonymous email address, the transaction with the merchant 104 continues using 770 the customer's real email address according to one embodiment. In another embodiment, the merchant has the option of opting out of use of anonymous emails, requiring the customer to enter a real email address. For example, if a customer attempts to use an anonymous email address, a prompt may display.

If the customer selects the option to generate a new anonymous email address, the broker 106 uses the transaction identification information to generate 780 a new anonymous email key and anonymous email address, and stores 790 the received information and new anonymous email key and address to the customer table. Because the customer is already authenticated, the transaction identification information is known to the broker 106.

If at least one anonymous email address exists corresponding to the received customer ID and merchant ID, the broker 106 adds an option to the representation of the shopping cart displayed on the client device to prompt 750 the customer to select one of the previously generated anonymous email addresses from a list displayed on the client device 102 or to create a new anonymous email address.

If the customer elects to use an existing anonymous email for the transaction, for example by selecting an existing anonymous email from the displayed list, the transaction continues using the existing anonymous email 760 selected by the customer. If the customer elects to generate a new anonymous email address, the broker 106 generates 780 a new anonymous email key and email as described above and stores 790 the information to the customer table.

In one embodiment, the broker 106 uses the email anonymization module 528 described in conjunction with FIG. 5 to perform the steps of FIG. 7. In another embodiment, an email address generator performs the step of generating 780 a new anonymous email address. When an anonymous email address is selected, the anonymous email address is transmitted to the merchant and is stored with the merchant according to one embodiment. The customer's anonymous email address is then used for subsequent communications between the merchant and the customer.

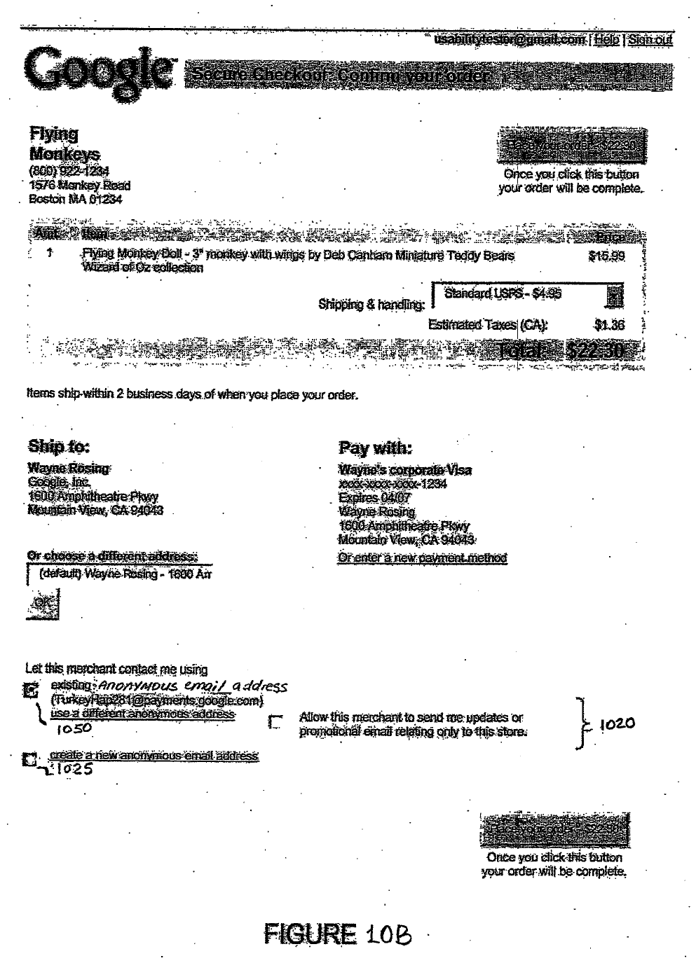

Referring now to FIG. 10A, it illustrates a sample checkout confirmation page from a merchant website. In addition to purchase information 1005, shipping information 1010, and payment information 1015, the page includes an email contact information area 1020 in one embodiment. The email contact information area 1020 includes radio buttons 1025 and 1035 that allow the user to select an address by which the merchant may contact the customer. In one embodiment, an anonymous email address button 1025 allows the user to avoid revealing his real email address by establishing an anonymous email address as described herein. The anonymous email address button 1025 is accompanied by a link 1030 for more information about anonymous email addresses according to one embodiment. Alternatively, the customer may select to enter an email address into the field accompanying the email address radio button 1035. In one embodiment, the email contact information area 1020 also includes the option to allow the merchant to send additional information to the customer via email.

Referring now to FIG. 10B, it illustrates a sample checkout confirmation page from a merchant website. In addition to the email contact information area 1020 including an anonymous email address button 1025 as described in conjunction with FIG. 10A, in this embodiment the area 1020 includes an existing anonymous email radio button 1050. The existing anonymous email radio button 1050 allows a customer with an existing anonymous email address to select it for use.

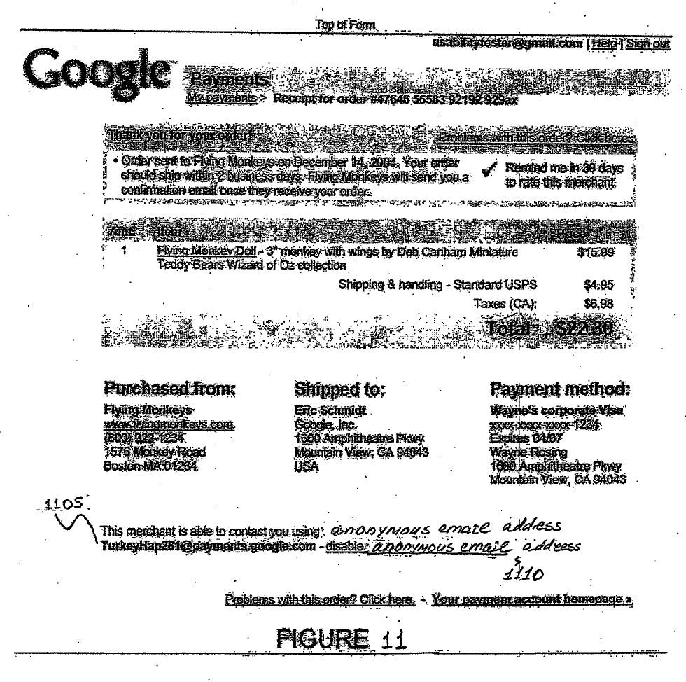

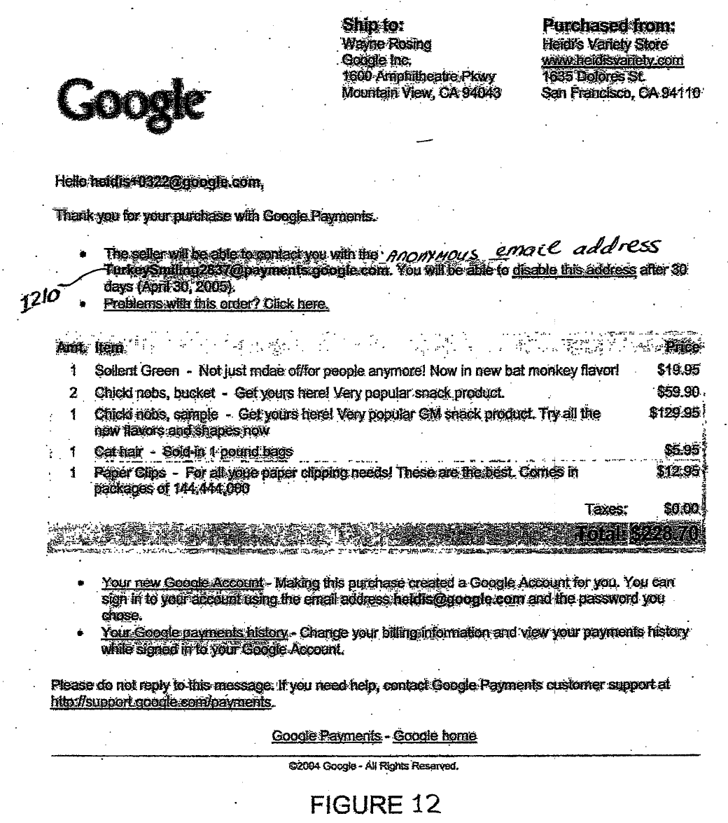

Referring now to FIG. 11, in one embodiment, the selected anonymous email address 1105 is listed on the customer receipt. In addition, a link 1110 allowing the customer to disable the anonymous email address also is included. The selected anonymous email address is also listed on an email order confirmation as shown in FIG. 12 according to one embodiment.

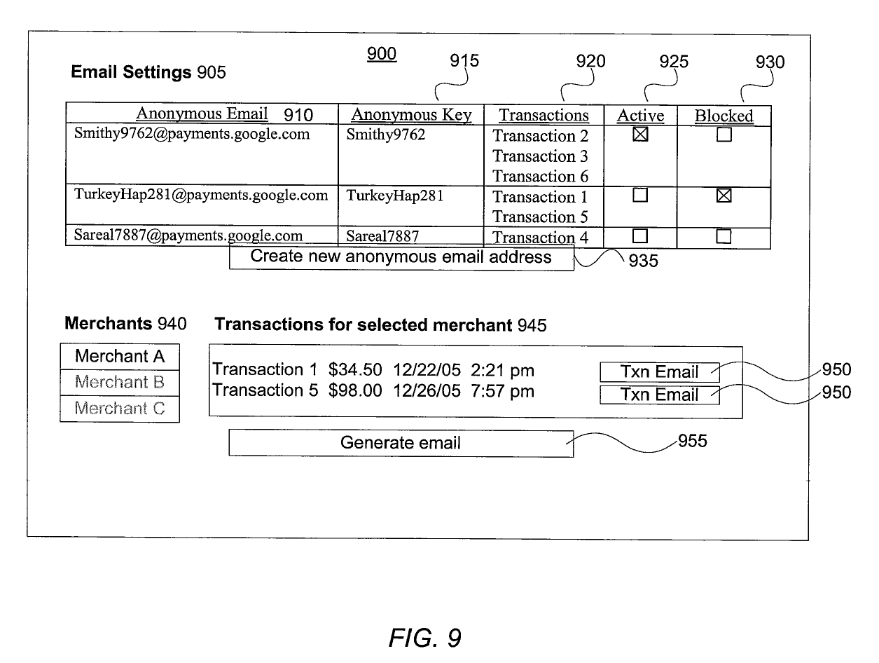

Referring now to FIG. 8 is a flow chart illustrating broker-mediated communication between the merchant 104 and customer. Those of skill in the art will recognize that other embodiments can perform the steps of FIG. 8 in different orders. Moreover, other embodiments can include different and/or additional steps than the ones described herein.

To communicate with the customer, the merchant sends an email to the customer's anonymous email address. The broker 106 receives 810 this email message and determines 820 the real customer email address. In one embodiment, the message is received 810 at a message router communicatively coupled to the broker 106, which recognizes the email as addressed to an anonymous email address and forwards the email to an email anonymization server.

In one embodiment, the broker 106 determines 830 whether the customer's anonymous email address is marked as active and unblocked. “Active,” as used herein, indicates that the email address is in use. In one embodiment, only one anonymous email address can be active at a time. “Blocked,” as used herein, indicates that the customer does not want email from the blocked anonymous email address forwarded to the customer's real email address. In one embodiment, the customer indicates whether an anonymous email address is active or inactive and blocked or unblocked via an account management user interface, as described further in conjunction with FIG. 9. In some embodiments, restrictions exist as to when anonymous email addresses may be marked inactive or blocked. For example, when an order is placed, the anonymous email selected for use in conjunction with the order may need to remain active for a certain period of time, e.g., thirty days. In another embodiment, changes to the active anonymous email address redirect all future mailings.

In this example, the received email message is only forwarded 840 to the customer's real email address if the customer's anonymous email address is marked active and unblocked (Yes connector). As an optional alternative, after determining 820 the real customer email address, the broker 106 forwards 840 the received email message to the customer's real email address (dotted connector 850).

If the customer's anonymous email address is marked inactive or is blocked, the email from the merchant is discarded 860. In some embodiments, the anonymous email server notifies 870 the merchant that the message could not be sent to the customer. For example, the merchant would receive a message indicating that the message was not received by the customer, and optionally indicating the reason the message was not sent, e.g. “The recipient has blocked email messages from your server.” In one embodiment, a message router performs steps 840-870.

FIG. 9 illustrates one embodiment of an account management interface 900. Those of skill in the art will recognize that different embodiments can provide the information and functionality of FIG. 9 in different ways. Moreover, other embodiments can include different and/or additional features and/or layouts than the ones described herein.

In one embodiment, the account management user interface 900 displays anonymous email settings 905, including a list of existing anonymous email addresses 910, their associated anonymous email keys 915, transactions conducted using each address 920, and whether each address is active 925 and/or blocked 930. The user can select or deselect the active 925 and blocked 930 boxes as desired according to one embodiment. According to another embodiment, only one anonymous email address can be active at one time, thus the active selectors 925 act as radio buttons. In addition, the customer may create a new anonymous email address by clicking the create new anonymous email button 935, according to the process described in conjunction with FIG. 7 according to one embodiment.

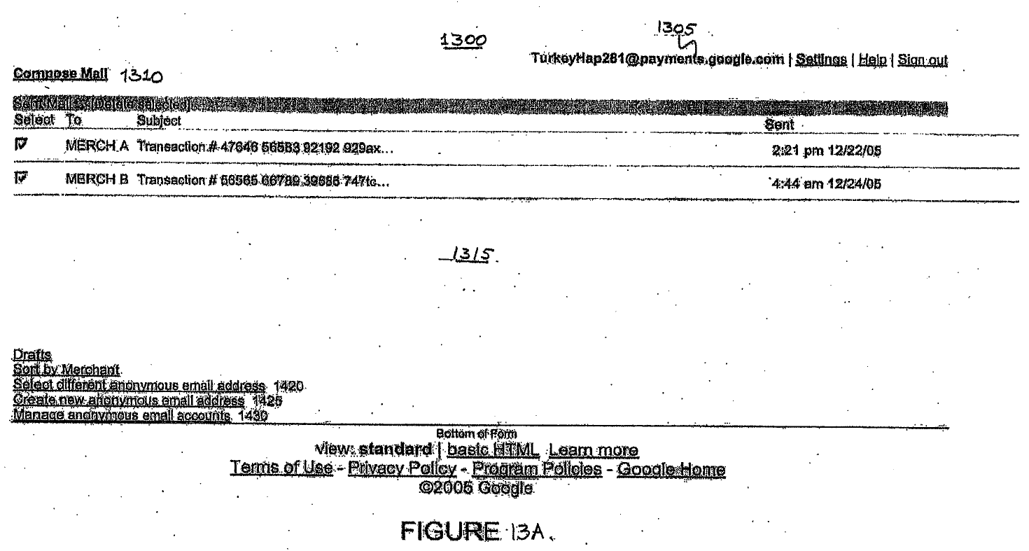

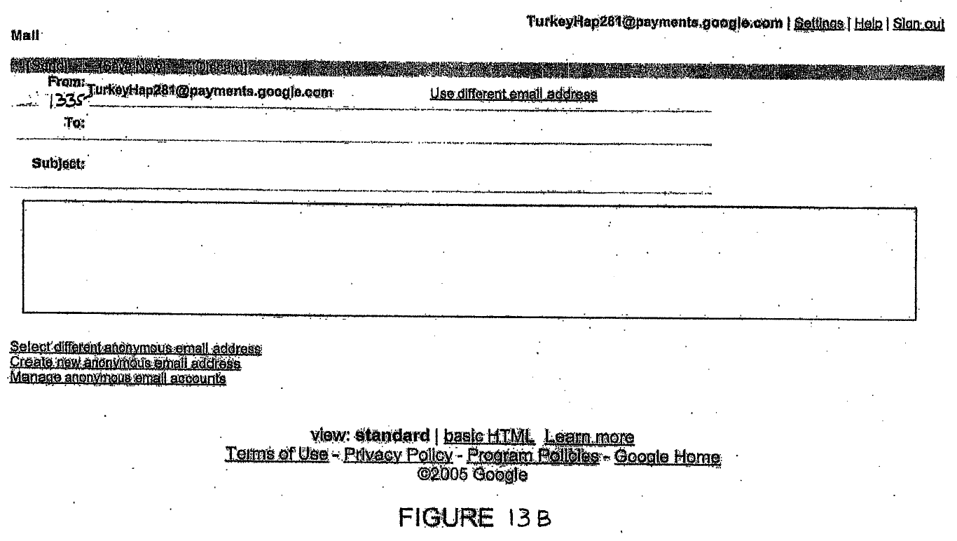

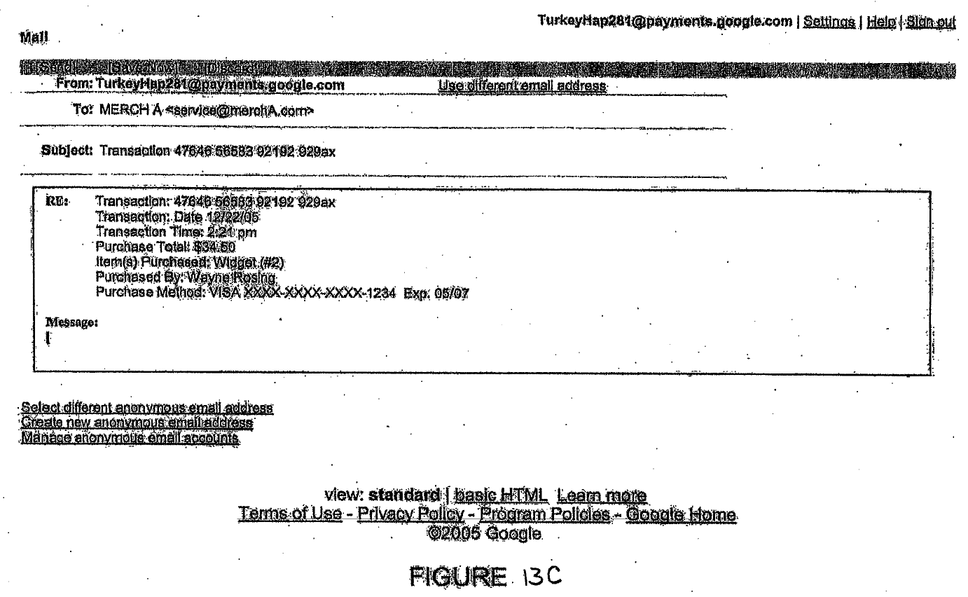

In one embodiment, the account management user interface 900 displays a list of merchants 940 the customer has patronized. The customer can select a merchant from the list, causing the user interface to display a list of transactions 945 corresponding to the selected merchant (e.g., Merchant A). Thus, the account management interface 900 allows customers to review transactions and send emails to merchants associated with the listed transactions. Upon selection of a merchant from the merchant list 940, the remaining merchants are grayed out or otherwise deemphasized (e.g., Merchants B and C) to differentiate them from the selected merchant. The transaction list 945 also includes a transaction email button 950 for each transaction. The transaction email button 950 generates an email to the merchant regarding the associated transaction, with pre-populated transaction information. An example of this email is displayed in FIG. 13C discussed below. In addition, if desired, the customer can generate an email not associated with a particular transaction by clicking the generate email button 955.

If the account management interface is used to send email to a merchant, the anonymous email account management interface will automatically include the transaction ID and transactions details such as the amount, product description and date, in the email and select the customer's anonymous email address associated with the selected merchant.

In one embodiment, the account management interface uses the customer communications module 510 to provide customers with an email interface, e.g., 1300 as shown in FIG. 13A, to send emails using the generated anonymous email addresses. In one embodiment, the customer accesses this email interface 1300 by selecting the generate email button 955 on the account management interface 900. The communications module 510 includes in one embodiment an email client 530 supporting the email interface 1300, which is send-only according to one embodiment to ensure that customers use their personal email system for reading emails. In another embodiment, the email client may also receive emails.

The email interface 1300 defaults to list emails sent from the currently active anonymous email address 1305 and includes a link 1310 that allows the customer to compose emails to merchants. The email interface 1300 lists emails 1315 sent to a merchant by the customer, in a standard format as known in the art. In addition, links are provided to switch to the emails for a different anonymous email address (1320), create a new anonymous email address (1325) as described herein, and manage anonymous email accounts (1330), e.g., via an account management interface such as 900 of FIG. 9. If the customer selects the compose mail link 1310, the customer can send emails from the anonymous email address, using a standard format email such as shown in FIG. 13B. In one embodiment, the from field 1335 defaults to the anonymous email address. If the customer composes a transaction-specific email, e.g., by selecting a transaction email button 950 as shown in FIG. 9, the email pre-populates with transaction details as shown in FIG. 13C.

The present invention has been described in particular detail with respect to various embodiments, and those of skill in the art will appreciate that the invention may be practiced in other embodiments. In addition, those of skill in the art will appreciate the following aspects of the disclosure. First, the particular naming of the components, capitalization of terms, the attributes, data structures, or any other programming or structural aspect is not mandatory or significant, and the mechanisms that implement the invention or its features may have different names, formats, or protocols. Second, the system may be implemented via a combination of hardware and software, as described, or entirely in hardware elements. Third, the particular division of functionality between the various system components described herein is merely exemplary, and not mandatory; functions performed by a single system component may instead be performed by multiple components, and functions performed by multiple components may instead performed by a single component.

Some portions of above description describe the invention in terms of algorithms and symbolic representations of operations on information. These algorithmic descriptions and representations are the means used by those skilled in the data processing arts to most effectively convey the substance of their work to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware or hardware.

In addition, the terms used to describe various quantities, data values, and computations are understood to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or the like, refer to the action and processes of a computer system, or similar electronic computing device, that manipulates and transforms data represented as physical (electronic) quantities within the computer system memories or registers or other such information storage, transmission or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, the present invention is not described with reference to any particular programming language. It is appreciated that a variety of programming languages may be used to implement the teachings of the present invention as described herein, and any references to specific languages are provided for disclosure of enablement and best mode of the present invention.

The present invention is well-suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

We claim:

1. A method for generating an anonymous email address, comprising:
receiving transaction identification information identifying a customer and a merchant;
generating an anonymous email key associated with the transaction identification information; and
generating an anonymous email address associated with the customer using the anonymous email key.

2. The method of claim 1 wherein the anonymous email key is generated using a pseudo-random number generation algorithm.

3. The method of claim 1 wherein the anonymous email key is generated by concatenating randomly selected words and number sequences.

4. The method of claim 1 further comprising generating the anonymous email key by generating a hash value of customer identification information.

5. The method of claim 1 further comprising generating the anonymous email key by generating a hash value of merchant identification information.

6. The method of claim 1 further comprising generating the anonymous email key by generating a hash value of a time stamp.

7. The method of claim 1 further comprising generating the anonymous email key by generating a hash value of a random number.

8. The method of claim 1, further comprising storing the anonymous email key, anonymous email address, and transaction identification information.

9. The method of claim 8, wherein the transaction identification information includes a customer ID, a merchant ID, a customer real email address, and a merchant email address.

10. The method of claim 1, further comprising checking the anonymous email key for uniqueness.

11. The method of claim 1, further comprising receiving and storing information specifying whether the anonymous email address is active and unblocked.

12. The method of claim 1, further comprising:
displaying to the customer an account management interface for modifying characteristics of existing anonymous email keys

13. A method for generating an anonymous email address, comprising:
receiving from a customer a request to generate an email message to a merchant;
providing the customer with an interface, which allows the customer to create an anonymous email address;
receiving transaction identification information identifying the customer and the merchant;
generating an anonymous email key associated with the transaction identification information; and
generating an anonymous email address associated with the customer using the anonymous email key.

14. The method of claim 13 wherein the anonymous email key is generated using a pseudo-random number generation algorithm.

15. The method of claim 13 wherein the anonymous email key is generated by concatenating randomly selected words and number sequences.

16. The method of claim 13 further comprising generating the anonymous email key by generating a hash value of customer identification information.

17. The method of claim 13 further comprising generating the anonymous email key by generating a hash value of merchant identification information.

18. The method of claim 13 further comprising generating the anonymous email key by generating a hash value of a time stamp.

19. The method of claim 13 further comprising generating the anonymous email key by generating a hash value of a random number.

20. A method for communication between a customer and a merchant using an anonymous email address, comprising:
receiving, from the merchant, an email addressed to an anonymous email address of the customer;
determining a real customer email address that corresponds to the anonymous email address;
determining whether the anonymous email address is active and unblocked; and
responsive to a determination that the anonymous email address is active and unblocked, forwarding the email addressed to the anonymous email address to the real customer email address.

21. The method of claim 20, further comprising:
responsive to a determination that the anonymous email address is inactive, discarding the email addressed to an anonymous email address.

22. The method of claim 20, further comprising:
responsive to a determination that the anonymous email address is blocked, discarding the email addressed to an anonymous email address.

23. The method of claim 20, further comprising:
responsive to the email being discarded, notifying the merchant that the email was not delivered.

24. A method for communication between a user and a merchant using an anonymous email address, comprising:
providing the user an account management interface for managing anonymous email addresses;
generating an anonymous email address associated with the user and the merchant;
receiving user input to create an email addressed to the merchant; and
transmitting the email addressed to the merchant listing from the anonymous email address.

25. The method of claim 24, wherein generating an anonymous email address further comprises:
receiving transaction identification information identifying the user and the merchant; and
generating an anonymous email key associated with the transaction identification information.

26. The method of claim 24, further comprising:
receiving, from the merchant, an email addressed to the anonymous email address;
determining a real user email address that corresponds to the anonymous email address;
determining whether the anonymous email address is active and unblocked; and
responsive to a determination that the anonymous email address is active and unblocked, forwarding the email addressed to the anonymous email address to the real user email address.

27. The method of claim 24 wherein the anonymous email key is generated using a pseudo-random number generation algorithm.

28. The method of claim 24 wherein the anonymous email key is generated by concatenating randomly selected words and number sequences.

29. The method of claim 24 further comprising generating the anonymous email key by generating a hash value of customer identification information.

30. The method of claim 24 further comprising generating the anonymous email key by generating a hash value of merchant identification information.

31. The method of claim 24 further comprising generating the anonymous email key by generating a hash value of a time stamp.

32. The method of claim 24 further comprising generating the anonymous email key by generating a hash value of a random number.

33. An electronic commerce system, comprising:
an email anonymization module for generating an anonymous email address corresponding to a customer and a merchant for use in transactions between the customer and the merchant; and
a communication module for allowing communication between the customer and the merchant using the anonymous email address.

34. The electronic commerce system of claim 33, wherein the communication module is further configured to allow the customer to access anonymous email account information.

35. The electronic commerce system of claim 33, wherein the communication module is further configured to manage delivery of emails received at the anonymous email address.

36. A system for generating an anonymous email address, comprising:
means for receiving transaction identification information identifying a customer and a merchant;
means for generating an anonymous email key associated with the transaction identification information; and
means for generating an anonymous email address associated with the customer using the anonymous email key.

37. A computer program product, including a computer readable medium storing thereon computer executable program modules, the product for generating an anonymous email address, the computer executable program modules comprising:
a first module programmed to receive transaction identification information identifying a customer and a merchant;
a second module programmed to generate an anonymous email key associated with the transaction identification information; and
a third module programmed to generate an anonymous email address associated with the customer using the anonymous email key.

38. A system for generating an anonymous email address, comprising:
means for receiving from a customer a request to generate an email message to a merchant;
means for providing the customer with an interface, which allows the customer to create an anonymous email address;
means for receiving transaction identification information identifying the customer and the merchant;
means for generating an anonymous email key associated with the transaction identification information; and
means for generating an anonymous email address associated with the customer using the anonymous email key.

39. A computer program product, including a computer readable medium storing thereon computer executable program modules, the product for generating an anonymous email address, the modules programmed to perform the operations comprising:
receiving from a customer a request to generate an email message to a merchant;
providing a user interface, which allows the customer to create an anonymous email address;
receiving transaction identification information identifying the customer and the merchant;
providing an anonymous email key associated with the transaction identification information; and
generating an anonymous email address associated with the customer using the anonymous email key.

40. A system for communication between a customer and a merchant using an anonymous email address, comprising:
means for receiving, from the merchant, an email addressed to an anonymous email address of the customer;
means for determining a real customer email address that corresponds to the anonymous email address;
means for determining whether the anonymous email address is active and unblocked; and
means for responsive to a determination that the anonymous email address is active and unblocked, forwarding the email addressed to the anonymous email address to the real customer email address.

41. A computer program product, including a computer readable medium storing thereon computer executable program modules, the product for managing communication between a customer and a merchant using an anonymous email address, the modules programmed to perform the operations comprising:
receiving, from the merchant, an email addressed to an anonymous email address of the customer;
determining a real customer email address that corresponds to the anonymous email address;
determining whether the anonymous email address is active and unblocked; and
responsive to a determination that the anonymous email address is active and unblocked, forwarding the email addressed to the anonymous email address to the real customer email address.
